(19) United States
(12) Patent Application Publication
(10) Pub. No.: US 2025/0260772 A1
(43) Pub. Date: Aug. 14, 2025

(54) IMAGE FORMING DEVICE

(71) Applicant: SHARP KABUSHIKI KAISHA, Sakai City (JP)

(72) Inventor: Kazumasa TONAMI, Sakai City (JP)

(21) Appl. No.: 19/053,317

(22) Filed: Feb. 13, 2025

(30) Foreign Application Priority Data
Feb. 14, 2024 (JP) 2024-019890

(51) Int. Cl. H04N 1/00; B41J 3/46; B41J 13/10; B41J 29/13; G03G 15/00; G03G 21/16

(52) U.S. Cl. CPC H04N 1/00392; B41J 3/46; B41J 13/106; B41J 29/13; G03G 15/5016; G03G 15/6552; G03G 21/1633; H04N 1/00037; H04N 1/00082; H04N 1/0049; H04N 1/00631; H04N 2201/0094

(57) ABSTRACT

An image forming device comprises: an image scanner; a printer provided below the image scanner; a sheet discharge tray provided between the image scanner and the printer and forming, between the sheet discharge tray and the image scanner, a sheet discharge space into which a sheet printed by the printer is discharged; and an operation panel attached on a front side of the image scanner, wherein the operation panel includes an operation unit operated by a user, a frame provided surrounding the operation unit, and a light emitter including a lamp that makes a predetermined notification to the user, and the light emitter protrudes from a lower portion of the frame at a position away from the sheet discharge space in a front view of the image forming device.

### CROSS-REFERENCE TO RELATED APPLICATION

The present application claims priority from Japanese Application JP2024-019890, the content to which is hereby incorporated by reference into this application.

### BACKGROUND OF THE DISCLOSURE

### 1. Field of the Disclosure

The present disclosure relates to an image forming device.

### 2. Description of the Related Art

In recent years, image forming devices have been developed. In such an image forming device, an operation panel is attached on a front side of an image scanning device. The operation panel is provided with a light emitter including a notification lamp that makes a predetermined notification of a state of the image forming device, such as an error, to a user.

### SUMMARY

In the above-described image forming device, a portion of the operation panel overlapping a sheet discharge space between a printer and an image scanner is large in a front view. Thus, the visibility of the sheet discharge space from a position on the front side of the image forming device is not good.

The present disclosure has been made in view of the problem described above. An object of the disclosure is to provide an image forming device in which a notification lamp is provided to improve the visibility of a sheet discharge space.

### Solution to Problem

An image forming device according to an aspect of the disclosure includes: an image scanner; a printer provided below the image scanner; a sheet discharge tray provided between the image scanner and the printer and forming, between the sheet discharge tray and the image scanner, a sheet discharge space into which a sheet printed by the printer is discharged; and an operation panel attached on a front side of the image scanner. The operation panel includes an operation unit operated by a user, a frame surrounding the operation unit, and a light emitter including a lamp that makes a predetermined notification to the user. The light emitter protrudes from a lower portion of the frame at a position away from the sheet discharge space in a front view of the image forming device.

### BRIEF DESCRIPTION OF THE DRAWINGS

FIG. 1 is a front view of an image forming device of a first embodiment.

FIG. 2 is a perspective view of the image forming device of the first embodiment.

FIG. 3 is a perspective view illustrating a state in which a door of the image forming device of the first embodiment is opened.

FIG. 4 is a front view of an image forming device of a second embodiment.

FIG. 5 is a functional block diagram of an image forming device of a third embodiment.

FIG. 6 is a diagram illustrating a state in which a light emitter of the image forming device of the third embodiment protrudes from a frame.

FIG. 7 is a diagram illustrating a state in which the light emitter of the image forming device of the third embodiment is accommodated in the frame.

FIG. 8 is a perspective view of an image forming device of a fourth embodiment.

### DETAILED DESCRIPTION OF THE DISCLOSURE

Image forming devices of embodiments of the disclosure will be described below with reference to the accompanying drawings. In the drawings, the same or equivalent elements are denoted by the same reference numerals and signs, and redundant descriptions will not be repeated.

### First Embodiment

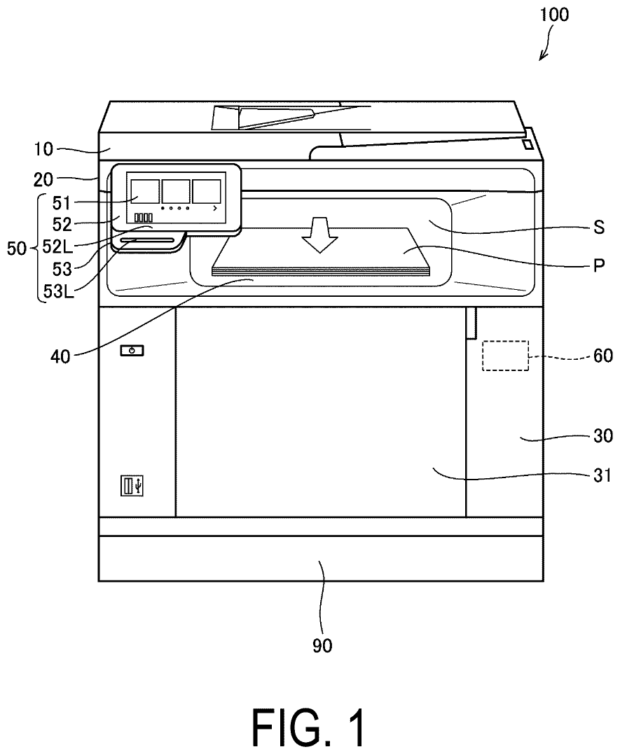

An image forming device 100 of a first embodiment will be described below with reference to FIG. 1 to FIG. 3.

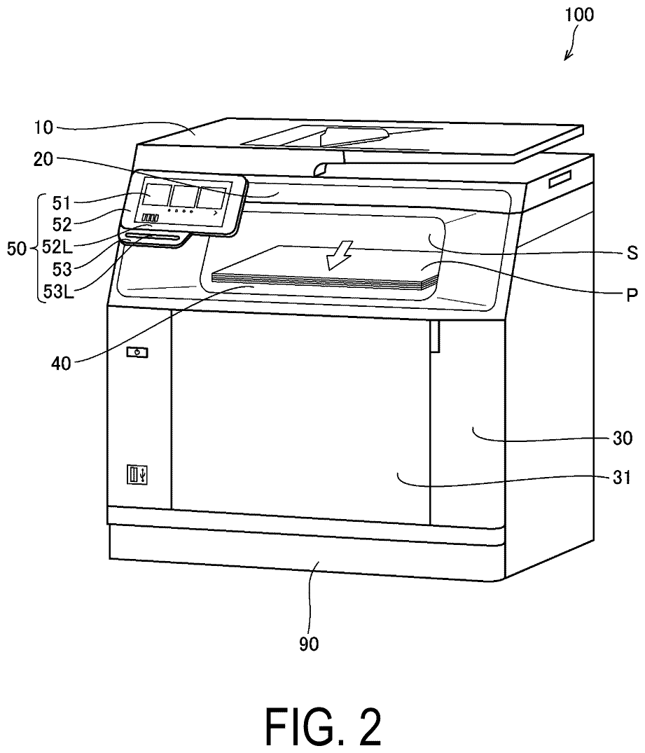

FIG. 1 is a front view of the image forming device 100 of the present embodiment. FIG. 2 is a perspective view of the image forming device 100 of the present embodiment.

The image forming device 100 according to the present embodiment illustrated in FIG. 1 and FIG. 2 is a multifunction peripheral having a copy function, a print function, a facsimile function, and a scanner function. As illustrated in FIG. 1 and FIG. 2, the image forming device 100 includes a document feeding device 10, an image scanner 20, a printer 30, a sheet discharge tray 40, an operation panel 50, a controller 60, and a sheet feed tray 90.

The document feeding device 10 automatically feeds a document supplied to a feed path by a user to the image scanner 20. The image scanner 20 scans an image drawn on the document fed through the feed path. Data of the image scanned by the image scanner 20 is transmitted to the controller 60.

The printer 30 is provided below the image scanner 20. The printer 30 includes a door 31 that opens to the front side of the image forming device 100. The printer 30 prints the data of the image scanned by the image scanner 20 on a sheet supplied from the sheet feed tray 90 based on a command signal transmitted from the controller 60.

The sheet discharge tray 40 is provided between the image scanner 20 and the printer 30. A sheet discharge space S to which a sheet P printed by the printer 30 is discharged is formed between the sheet discharge tray 40 and the image scanner 20. The sheet discharge space S is a recessed portion recessed from the front side toward the back side of the image forming device 100. The sheet P printed by the printer 30 is discharged to the sheet discharge space S above the sheet discharge tray 40 in a direction indicated by the open arrows in FIG. 1 and FIG. 2. That is, the printed sheet P is discharged from the back side to the front side of the sheet discharge space S. However, the printed sheet P may be discharged from the right side to the left side of the sheet discharge space S, or may be discharged from the left side to the right side of the sheet discharge space S.

The operation panel 50 is a touch panel on which icons and the like are displayed. The operation panel 50 transmits a command signal to the controller 60 in response to a user's operation. The controller 60 controls the printing operation of the printer 30 based on a command signal transmitted from the operation panel 50. The controller 60 controls the state of turning on, turning off, or blinking of a lamp 53L for notification based on a command signal transmitted from the operation panel 50.

The operation panel 50 is attached on the front side of the image scanner 20. The operation panel 50 includes an operation unit 51, a frame 52, and a light emitter 53. The frame 52 of the operation panel 50 may include a push button switch.

The operation unit 51 includes a touch panel configured to be operated by a user. The frame 52 is provided so as to surround the operation unit 51. The operation unit 51 is formed of a liquid crystal panel, and the frame 52 is formed of plastic. The light emitter 53 includes the lamp 53L for making a predetermined notification to a user. The lamp 53L notifies a state of the image forming device 100 such as a state in which an error such as a paper jam occurs by lighting or the like, for example. The light emitter 53 which is horizontally long includes therein the lamp 53L which is horizontally long. The lamp 53L is configured with a light emitting diode and a plastic cover that diffuses the light emitted by the light emitting diode.

The light emitter 53 protrudes from a lower portion 52L of the frame 52 at a position away from the sheet discharge space S in a front view (see FIG. 1) of the image forming device 100. That is, the light emitter 53 is provided so as not to overlap with the sheet discharge space S in the front view of the image forming device. Thus, the lamp 53L for notification can be provided to improve the visibility of the sheet discharge space S from a position on the front side of the image forming device 100. In addition, the possibility of occurrence of jamming due to a contact between the sheet P discharged onto the sheet discharge tray 40 and the light emitter 53 can be reduced.

Each corner of the light emitter 53 are formed in a curved shape, and corners having an acute angle are not provided. Accordingly, even when a user's hand or the like is brought into contact with a corner of the light emitter 53, the possibility of injury to the user is reduced.

A part of a lower portion of the operation panel 50 is provided at a position overlapping with the sheet discharge space S in a front view of the image forming device 100. Thus, it is possible to provide the lamp 53L to improve the visibility of the sheet discharge space S while improving the operability of the operation panel 50 for a user by increasing the size of the operation panel 50.

In the present embodiment, the operation panel 50 is provided at a position offset to the left side in a front view of the image forming device 100. Thus, the light emitter 53 protrudes from the lower portion 52L of the frame 52 at a position on the left side of the operation panel 50 in a front view of the image forming device 100.

According to this configuration, the lamp 53L for making a predetermined notification to a user can be provided to improve the visibility of the sheet discharge space S, by effectively using the arrangement of the operation panel 50 offset to the left side.

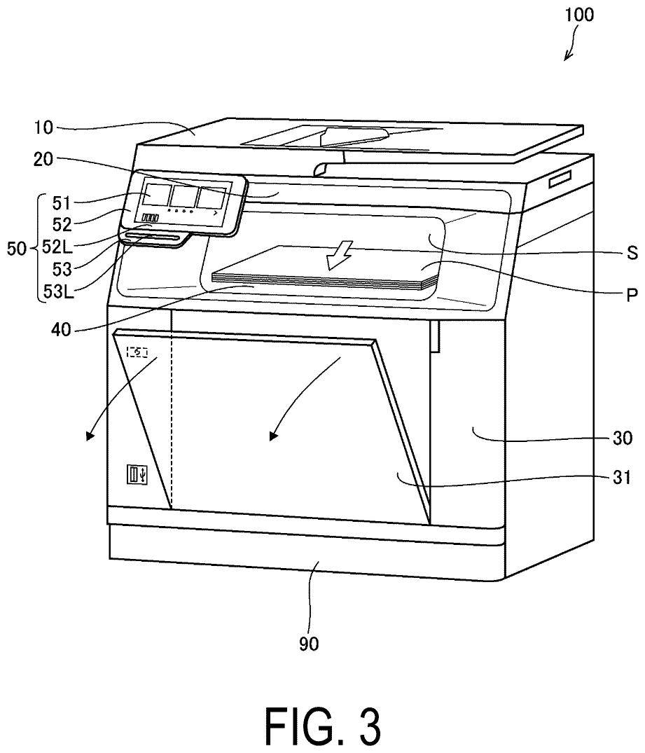

FIG. 3 is a perspective view illustrating a state in which the door 31 of the printer 30 of the image forming device 100 of the present embodiment is opened. Note that the arrows in FIG. 3 indicate a direction in which the door 31 is opened.

As illustrated in FIG. 3, the light emitter 53 protrudes from the lower portion 52L of the frame 52 at a position away from the opening and closing path of the door 31, in other words, the movement locus of the door 31 in a front view of the image forming device 100. Thus, it is possible to provide the lamp 53L for notification to improve the visibility of the sheet discharge space S while preventing the light emitter 53 from obstructing the opening and closing of the door 31 of the printer 30 by a user.

### Second Embodiment

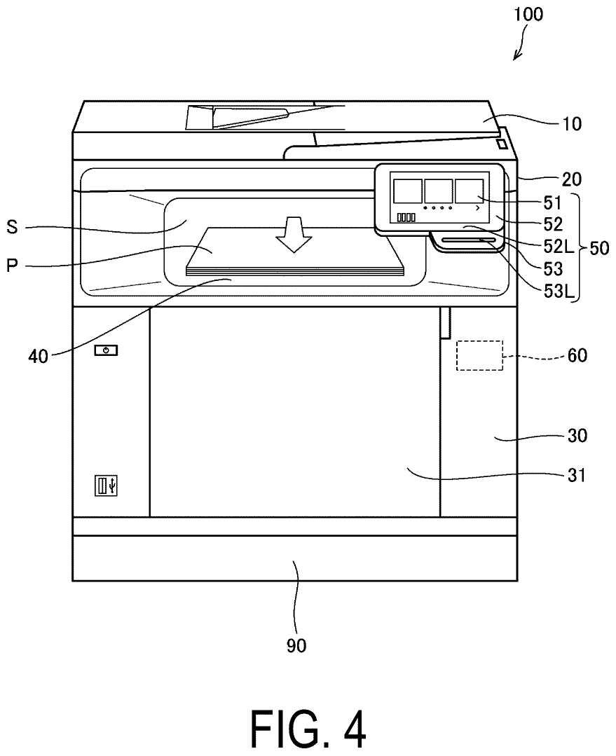

An image forming device 100 of a second embodiment will be described below with reference to FIG. 4. In the following, description of points similar to those of the image forming device 100 of the first embodiment will not be repeated. The image forming device 100 of the present embodiment differs from the image forming device 100 of the first embodiment in the following points.

FIG. 4 is a front view of the image forming device 100 of the present embodiment. In FIG. 4, the open arrow indicates a discharge direction of the sheet P to the sheet discharge space S.

As illustrated in FIG. 4, in the present embodiment, the operation panel 50 is provided at a position offset to the right side in a front view of the image forming device 100. Thus, in the image forming device 100 of the present embodiment, the light emitter 53 protrudes from the lower portion 52L of the frame 52 at a position on the right side of the operation panel 50 in a front view of the image forming device 100 (see FIG. 4).

According to this configuration, the lamp 53L for making a predetermined notification to a user can be provided to improve the visibility of the sheet discharge space S, by effectively using the arrangement of the operation panel 50 offset to the right side.

### Third Embodiment

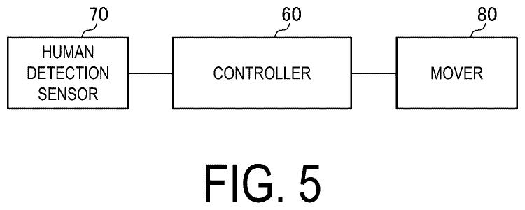

An image forming device 100 of a third embodiment will be described below with reference to FIG. 5 to FIG. 7. In the following, description of points similar to those of the image forming device 100 of the first embodiment or the second embodiment will not be repeated. The image forming device 100 of the present embodiment differs from the image forming device 100 of the first embodiment or the second embodiment in the following points.

FIG. 5 is a functional block diagram of the image forming device 100 of the present embodiment.

As illustrated in FIG. 5, the image forming device 100 of the present embodiment further includes a human detection sensor 70 and a mover 80 in addition to the components of the image forming device 100 of the first embodiment.

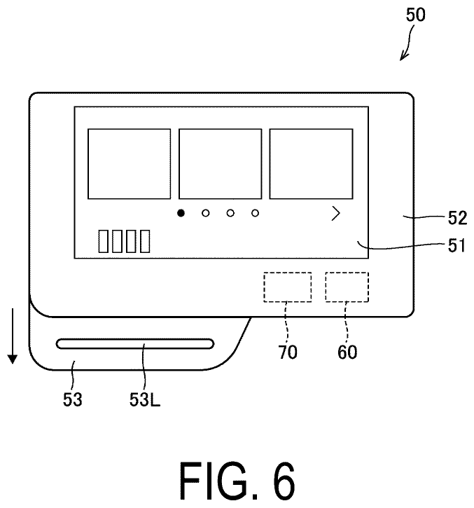

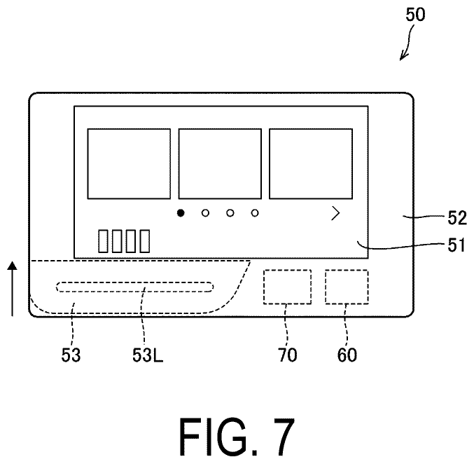

The human detection sensor 70 detects that a user is present at a position within a predetermined range from a reference position of the image forming device 100, and transmits a detection signal capable of identifying the user to the controller 60. The mover 80 is a mechanism that is controlled by the controller 60 to move the light emitter 53 with respect to the frame 52. The mover 80 switches between a state in which the light emitter 53 protrudes from the frame 52 (see FIG. 6) and a state in which the light emitter 53 is accommodated in the frame 52 (see FIG. 7). When the human detection sensor 70 does not detect the presence of a user at any position within the predetermined range from the reference position of the image forming device 100, the light emitter 53 is being accommodated in the frame 52 (see FIG. 7).

FIG. 6 is a diagram illustrating a state in which the light emitter 53 of the image forming device 100 of the present embodiment protrudes from the frame 52. FIG. 7 is a diagram illustrating a state in which the light emitter 53 of the image forming device 100 of the present embodiment is accommodated in the frame 52. The arrows illustrated in FIG. 6 and FIG. 7 indicate the moving direction of the light emitter 53.

In the present embodiment, the controller 60 controls the mover 80 to move the light emitter 53 based on the detection result of the human detection sensor 70. There is a case in which the human detection sensor 70 detects the presence of a user at a position within the predetermined range from the reference position of the image forming device 100.

In this case, the controller 60 controls the mover 80 to switch the state of the operation panel 50 from the state in which the light emitter 53 protrudes from the frame 52 as illustrated in FIG. 6 to the state in which the light emitter 53 is accommodated in the frame 52 as illustrated in FIG. 7. Accordingly, in a state in which the user is using the image forming device 100, the light emitter 53 is prevented from protruding to interfere with the user's operation or work at a position in front of the operation panel 50.

### Fourth Embodiment

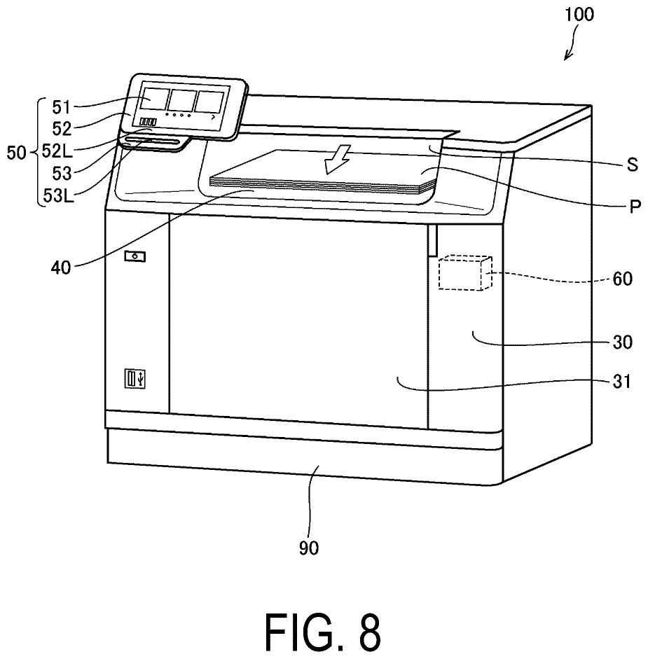

An image forming device 100 of a fourth embodiment will be described below with reference to FIG. 8. In the following, description of points similar to those of the image forming device 100 of the first to third embodiments will not be repeated. The image forming device 100 of the present embodiment differs from the image forming device 100 of the first to third embodiments in the following points.

FIG. 8 is a perspective view of the image forming device 100 of the present embodiment. In FIG. 8, the open arrow indicates a discharge direction of the sheet P to the sheet discharge space S.

As illustrated in FIG. 8, the image forming device 100 of the present embodiment is a printer-only machine. Even in such a printer-only machine, when the relationship between the operation panel 50 and the sheet discharge space S in a front view as described in the first to third embodiments is established, the same effects as those described in the first to third embodiments can be obtained.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. An image forming device comprising:
an image scanner;
a printer provided below the image scanner;
a sheet discharge tray provided between the image scanner and the printer and forming, between the sheet discharge tray and the image scanner, a sheet discharge space into which a sheet printed by the printer is discharged; and
an operation panel attached on a front side of the image scanner, wherein
the operation panel includes
an operation unit operated by a user,
a frame provided surrounding the operation unit, and
a light emitter including a lamp that makes a predetermined notification to the user, and
the light emitter protrudes from a lower portion of the frame at a position away from the sheet discharge space in a front view of the image forming device.

2. The image forming device according to claim 1, wherein a part of a lower portion of the operation panel is provided at a position overlapping with the sheet discharge space in the front view.

3. The image forming device according to claim 1, wherein
the printer includes a door that opens to a front side of the image forming device, and
the light emitter protrudes from the lower portion of the frame at a position away from an opening and closing path of the door in the front view.

4. The image forming device according to claim 1, further comprising:
a human detection sensor that detects that the user is present at a position within a predetermined range from a reference position of the image forming device;
a mover that moves the light emitter with respect to the frame; and
a controller that controls the mover to move the light emitter based on a detection result of the human detection sensor, wherein
when the human detection sensor detects that the user is present at the position within the predetermined range from the reference position, the controller controls the mover to switch a state of the operation panel from a state in which the light emitter protrudes from the frame to a state in which the light emitter is accommodated in the frame.

5. The image forming device according to claim 1, wherein
the operation panel is provided at a position offset to a left side in the front view, and
the light emitter protrudes from the lower portion of the frame at a position on a left side of the operation panel in the front view.

6. The image forming device according to claim 1, wherein
the operation panel is provided at a position offset to a right side in the front view, and
the light emitter protrudes from the lower portion of the frame at a position on a right side of the operation panel in the front view.
